(19) United States
(12) Patent Application Publication
(10) Pub. No.: US 2012/0327099 A1
(43) Pub. Date: Dec. 27, 2012

(54) DYNAMICALLY ADJUSTED DISPLAY ATTRIBUTES BASED ON AUDIENCE PROXIMITY TO DISPLAY DEVICE

(76) Inventor: William John Vojak, Battle Ground, WA (US)

(21) Appl. No.: 13/168,140

(22) Filed: Jun. 24, 2011

(51) Int. Cl. G09G 5/00

(52) U.S. Cl. 345/581

(57) ABSTRACT

Methods and devices for dynamical adjustment of display attributes, based on a set of one or more detected objects disposed in a volume proximate to an image display of the imaging device, wherein the set of one or more objects may be within a perimeter distal from a reference point of the image display. The method and devices further determining a distance from the reference point of the image display to a reference point of at least one of the one or more objects, and determining, for at least one of the one or more sub-regions of the image display, a set of one or more viewing attributes and a disposition on the image display of the at least one of the one or more sub-regions, wherein the set of viewing attributes and the disposition on the image display may be based on the determined distance and a rule set.

### BACKGROUND

Typically, an image display may be used in conference room environments to effect the sharing of information during meetings and allow the display of information, such as charts, tables, videos, and presentations. Audience members may also view signage displayed on screens and in such environments, a set of information may be conveyed by the display screen to the audience members.

### SUMMARY

Embodiments include methods of, and systems, and devices for dynamical adjustment of display attributes based on detected objects where, for example, a device embodiment may include (a) a device comprising: an image display, the image display comprising one or more sub-regions disposed on the image display, each of the one or more sub-regions having a set of one or more viewing attributes; (b) an addressable memory, the memory comprising a rule set, wherein the sub-regions of the image display may be responsive to at least one member of the rule set; and (c) a processor configured to: (i) detect a set of one or more objects disposed in a volume proximate to the image display and within a perimeter distal from a reference point of the image display; (ii) determine a distance from the reference point of the image display to a reference point of the one or more objects; and (iii) determine the set of one or more viewing attributes and the disposition of the one or more sub-regions of the image display, wherein the viewing attributes and disposition of the one or more sub-regions may be based on the determined distance of the one or more objects and at least one member of the rule set.

Optionally, the processor of the device may be further configured to position the one or more sub-regions on the image display based on the determined set of one or more viewing attributes and the determined disposition of the one or more sub-regions. In another embodiment, the device may be further configured to determine a level of audio output based on the determined set of viewing attributes and the determined distance. Optionally, the processor may be further configured to determine a set of one or more regional elements, wherein each regional element may comprise a weighting factor associated with each of the one or more objects.

Optionally, the set of regional elements may be determined based on the weighting factor associated with each of the one or more objects and may be based on the determined distance of the one or more objects disposed within the volume. Each of the one or more sub-regions may be associable with a priority of display. In one embodiment, the processor may be further configured to determine the set of viewing attributes and the disposition of the one or more sub-regions of the image display based on the associable priority of display of the one or more sub-regions.

In some embodiments, the set of viewing attributes may comprise at least one of: a set of dimensions in proportion to a set of dimensions of the image display; a set of font types; a set of font sizes; and a set of display content. Optionally, the processor may be further configured to determine the distance from the reference point of the image display to the reference point of the one or more objects via at least one of: a triangulation method, a trilateration method, and a multilateration method.

Exemplary method embodiments may include the steps of: (a) detecting, by a processor of an imaging device, a set of one or more objects disposed in a volume proximate to an image display of the imaging device, wherein the set of one or more objects may be within a perimeter distal from a reference point of the image display; (b) determining a distance from the reference point of the image display to a reference point of at least one of the one or more objects; and (c) determining, for at least one of the one or more sub-regions of the image display, a set of one or more viewing attributes and a disposition on the image display of the at least one of the one or more sub-regions, wherein the set of viewing attributes and the disposition on the image display may be based on the determined distance and a rule set. Optionally, the method embodiment may include the step of positioning for at least one of the one or more sub-regions of the image display based on the determined set of one or more viewing attributes, and the determined disposition on the image display, of the at least one of the one or more sub-regions of the image display.

In one exemplary embodiment, the method embodiment may include the step of determining a level of audio output based on the determined set of viewing attributes and the determined distance. Optionally, the method may include determining a set of one or more regional elements, wherein each regional element comprises a weighting factor associated with each of the one or more objects. Optionally, the set of regional elements may be determined based on the weighting factor associated with each of the one or more objects and based on the determined distance of the one or more objects disposed within the volume. Further, each of the one or more sub-regions may be associable with a priority of display. The method may further comprise the step of determining the set of viewing attributes and the disposition of the one or more sub-regions of the image display based on the associable priority of display of the one or more sub-regions.

Optionally, the set of viewing attributes may comprise at least one of: a set of dimensions in proportion to a set of dimensions of the image display; a set of font types; a set of font sizes; and a set of display content. In one embodiment, the method may further comprise the step of determining the distance from the reference point of the image display to the reference point of the one or more objects via at least one of: a triangulation method, a trilateration method, and a multilateration method.

Exemplary system embodiments may include an image display device, the image display device comprising an image display region having one or more sub-regions disposed on the image display region, each of the one or more sub-regions having a set of one or more viewing attributes, the image display device operably coupled to an image capture device via a communication medium, the image display device comprising: (i) a memory configured to store a rule set, wherein the sub-regions of the image display may be responsive to at least one member of the rule set; (ii) a processor configured to: (a) detect a set of one or more objects disposed in a volume proximate to the image display device and within a perimeter distal from a reference point of the image display; (b) determine a distance from the reference point of the image display to a reference point of the one or more objects; (c) determine the set of one or more viewing attributes and a disposition of the one or more sub-regions of the image display, wherein the viewing attributes and disposition of the one or more sub-regions may be based on the determined distance of the one or more objects and at least one member of the rule set; and (d) position the one or more sub-regions on the image display based on the determined set of one or more viewing attributes and the determined disposition of the one or more sub-regions.

### BRIEF DESCRIPTION OF THE DRAWINGS

Embodiments are illustrated by way of example and not limitation in the figures of the accompanying drawings, and in which:

FIG. 1 is a functional block diagram depicting an exemplary dynamic sub-region attribute adjustment and display system;

FIG. 2 is a functional block diagram depicting an exemplary dynamic sub-region attribute adjustment and display system;

FIG. 3 is a flowchart of an exemplary process;

FIG. 4 illustrates an exemplary top level functional block diagram of a computing device embodiment;

FIGS. 5A-5B depict a set of sub-regions on an image display;

FIGS. 6A-6C depict an environment with image capture devices;

FIGS. 7A-7C depict exemplary environments comprising an image display;

FIGS. 8A-8C depict embodiments of an environment apportioned according to a set of zones;

FIG. 9 is an exemplary table of values;

FIGS. 10A-10D depict a digital signage environment; and

FIG. 11 is a flowchart of an exemplary dynamic sub-region attribute adjustment process.

### DETAILED DESCRIPTION

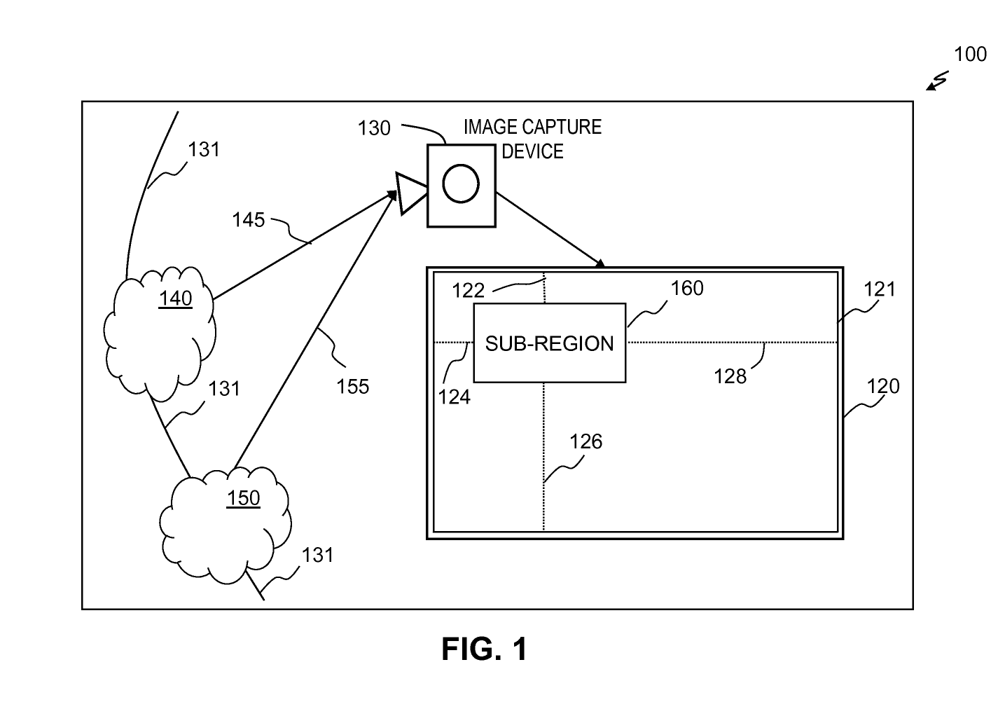

FIG. 1 is a functional block diagram depicting an exemplary dynamic image display sub-region attribute adjustment system 100. A system embodiment is depicted in FIG. 1 as comprising a set of one or more objects 140, 150, an image capture device 130, and an image display device 120. The image display 120 comprises a display region 121 that may comprise one or more sub-regions 160 that may be positioned on the display according to a distance X₁ 124 and X₂ 128 along a first axis and Y₁ 122 and Y₂ 126 along a second, e.g., orthogonal, axis. Embodiments of the dynamic sub-region attribute adjustment system 100 may be executed in real time or near real time, and information from the image capture device 130 may be at least one of received, read, and captured. The image capture device 130 is depicted as capturing a set of one or more objects 140, 150 that may be within a perimeter 131 distal from and defined by the location of the image display 120. A distance 145, 155 from a reference point of the image display to a reference point of the set of objects may also be calculated. The image capture device 130 may comprise one or a plurality of each of the following: camera; video capturing device; digital video recorder; scanning camera; webcam; and motion capture device. The image display 120 may be operably coupled to a computer processing device that may be configured to accept and store a rule set that may be pre-determined, pre-programmed, or inputted by a user via a user interface. In some embodiments, the computer processing device may be part of the image display. A rule set may be determined using the inputted parameters which may be identified and implemented. An object 140, 150 may be detected and captured by the image capture device 130, and a rule set may be determined and executed based on the distance of the reference point of the object to the image display. The rule set of each image display may additionally contain a set of instructions associated with the specific image display 120 and the specific environment. The image display may comprise a sub-region 160 that may display, for example, audiovisual windows, within the region, i.e., the display area of the image display. Additionally, the image display may capture the set of one or more objects continually or at predetermined time intervals.

In some embodiments, the image display may comprise a set of viewing attributes that may be modified, for example, based on the rule set, to effect the image display to display sub-regions according to the relative disposition of the set of objects 140, 150. The viewing attributes may be at least one of: sub-region size, window size, font size, icon size, graphics size, content size, and content information. Additionally, the volume of the audio output and/or microphone sensitivity may also be effected by the rule set. For example, the speakers in the back and/or front of a display viewing volume, such as a room, may be turned on, off or adjusted, and the volume level adjusted for each speaker separately. As another example, the microphones in the back and/or front of the room may be turned on, off or adjusted, and the sensitivity of each microphone adjusted separately. A collaboration environment may comprise audience members sitting at a determinable distance from the image display. The distances of the audience members may be detected by an image capture device and content may be displayed on the image display according to the determined distances of the audience members. In an embodiment where the audience members may be sitting at a distance from the image display, the image display may display the content of each sub-region according to the rule set which may accordingly prioritize the sub-regions within the display.

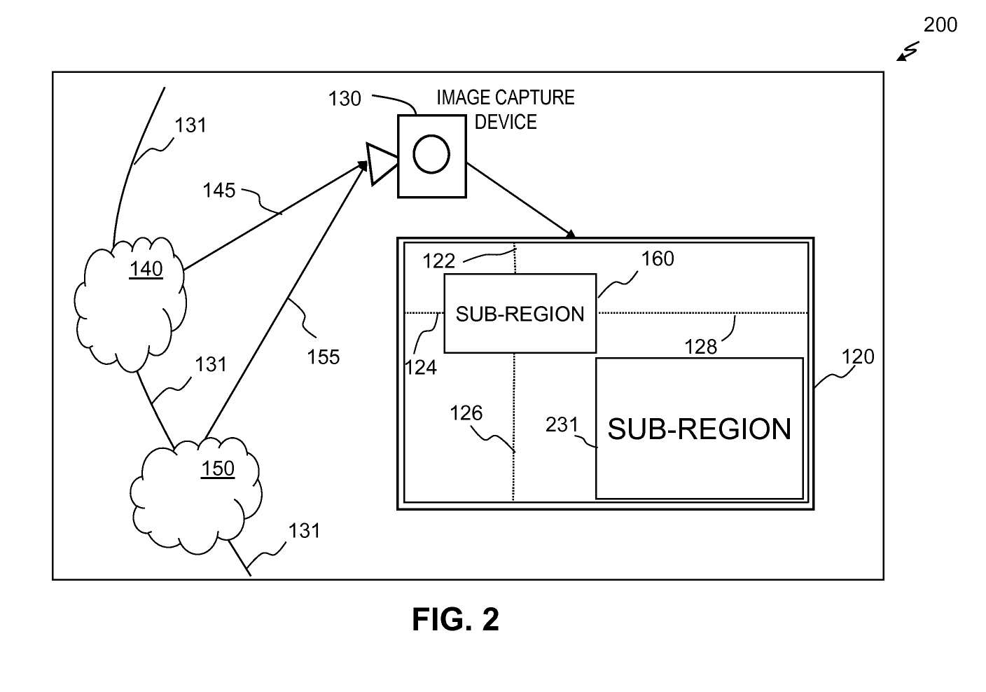

FIG. 2 is a functional block diagram depicting the exemplary dynamic sub-region attribute adjustment system of FIG. 1 where a second sub-region 231 is depicted as having a set of viewing attributes that are bigger in proportion to the first sub-region 160. The image display 120 may determine that—according to the rule set—for example, the size and font attributes of the second sub-region may be proportionally bigger than the size and font attributes of the first sub-region 160. Embodiments of the dynamic sub-region attribute adjustment system 200 may determine a set of priorities for each sub-region, and, for example, one sub-region 231 may have a higher priority than another sub-region 160. In another embodiment, the dynamic sub-region attribute adjustment system 200 may determine that, for example, according to the location of the set of objects 140, 150, the second sub-region 231 may have a proportionally bigger size than the first sub-region 160 in order to accommodate the ability of the objects, e.g., audience members or participants, to view the content of the second sub-region 231. The audience members may comprise the set of objects 140, 150.

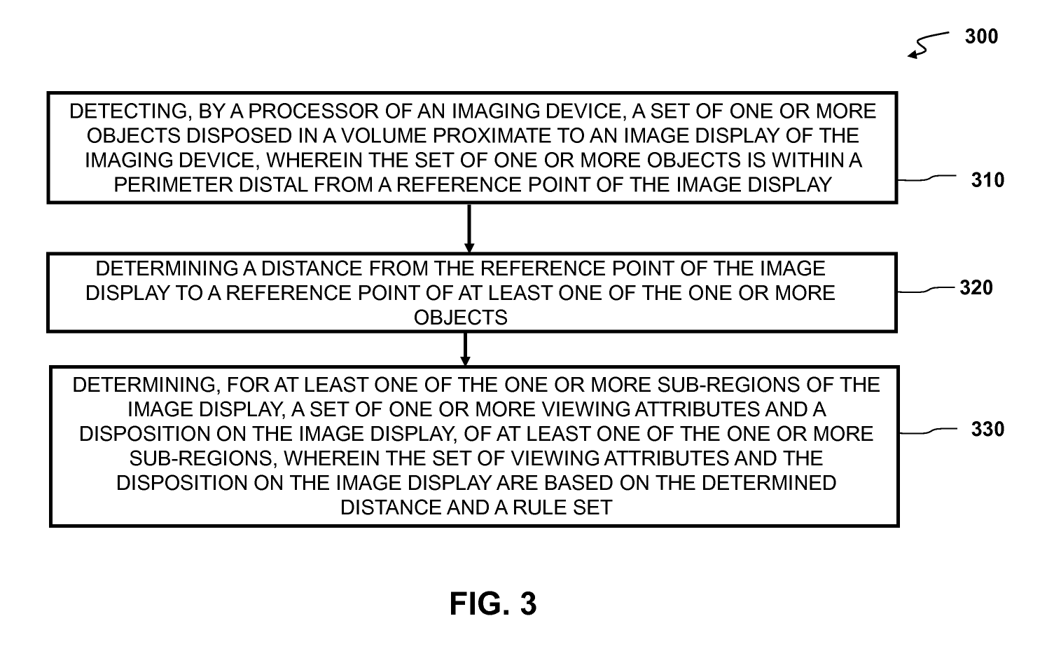

FIG. 3 is a flowchart of an exemplary dynamic sub-region attribute adjustment process 300 in which the system comprises an image display and computer and/or computing circuitry that may be configured to execute the steps as depicted. The method depicted in the flowchart includes the steps of: (a) detecting, by a processor of an imaging device, a set of one or more objects disposed in a volume proximate to an image display of the imaging device, wherein the set of one or more objects is within a perimeter distal from a reference point of the image display (step 310); (b) determining a distance from the reference point of the image display to a reference point of at least one of the one or more objects (step 320); and, (c) determining, for at least one of the one or more sub-regions of the image display, a set of one or more viewing attributes and a disposition, of at least one of the one or more sub-regions, on the image display, wherein the set of viewing attributes and the disposition on the image display are based on the determined distance and a rule set (step 330).

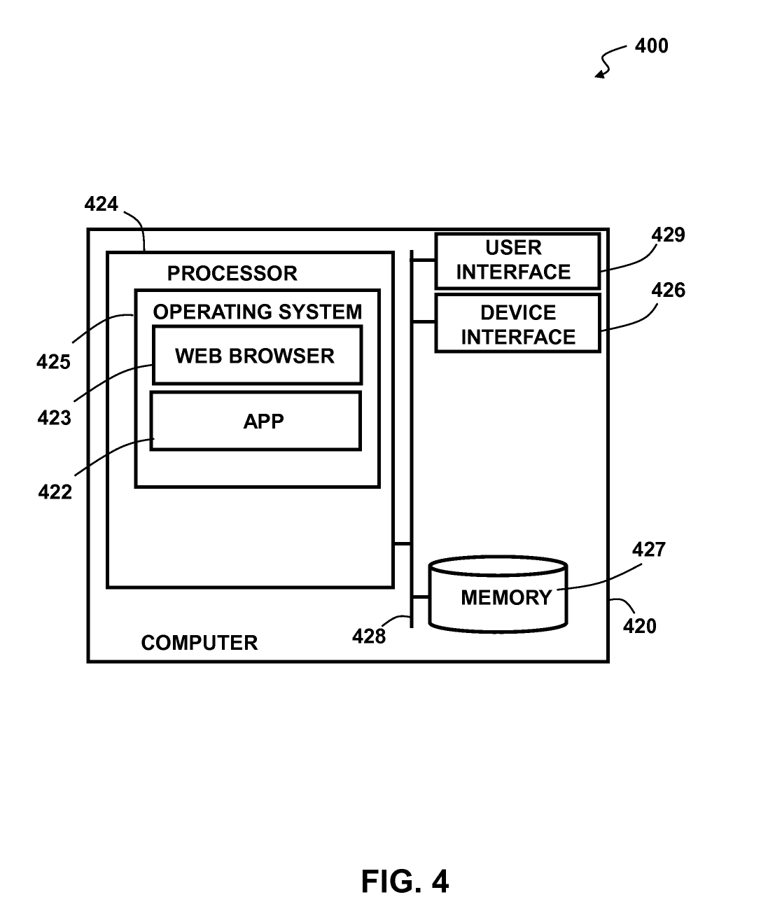

FIG. 4 illustrates an exemplary top level functional block diagram of a computing device embodiment 400. The exemplary operating environment is shown as a computing device 420 comprising a processor 424, such as a central processing unit (CPU), addressable memory 427, an external device interface 426, e.g., an optional universal serial bus port and related processing, and/or an Ethernet port and related processing, and an optional user interface 429, e.g., an array of status lights and one or more toggle switches, and/or a display, and/or a keyboard and/or a pointer-mouse system and/or a touch screen. These elements may be in communication with one another via a data bus 428. Via an operating system 425, such as one supporting an optional web browser 423 and applications 422, the processor 424 may be configured to execute steps of a dynamic sub-region attribute adjustment method (e.g., FIG. 3) according to the exemplary embodiments described above.

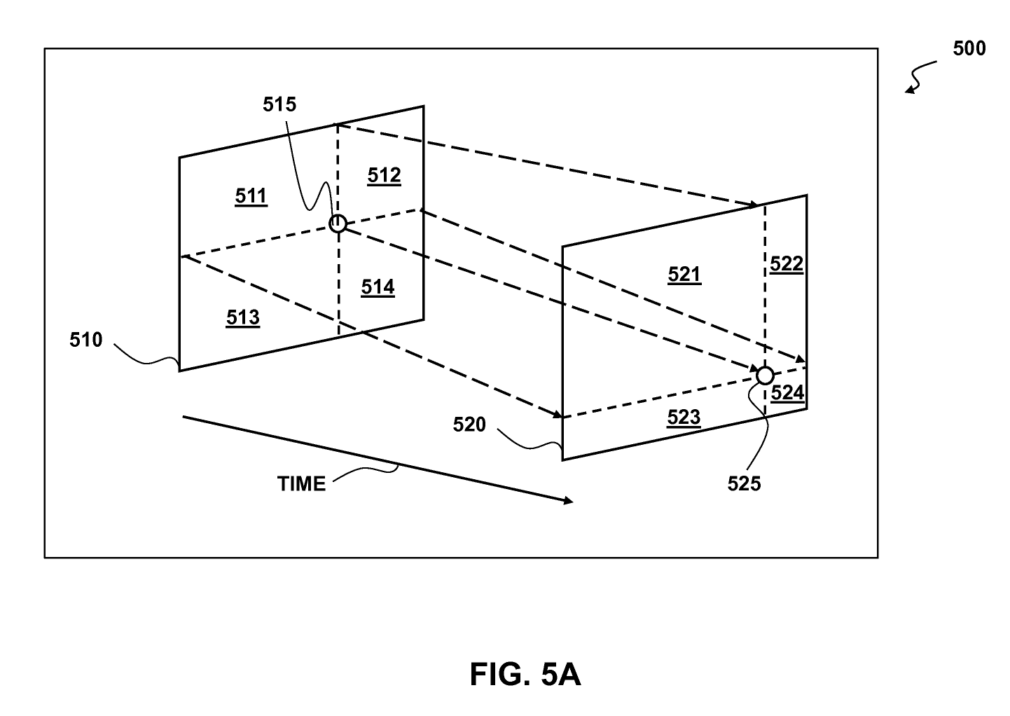

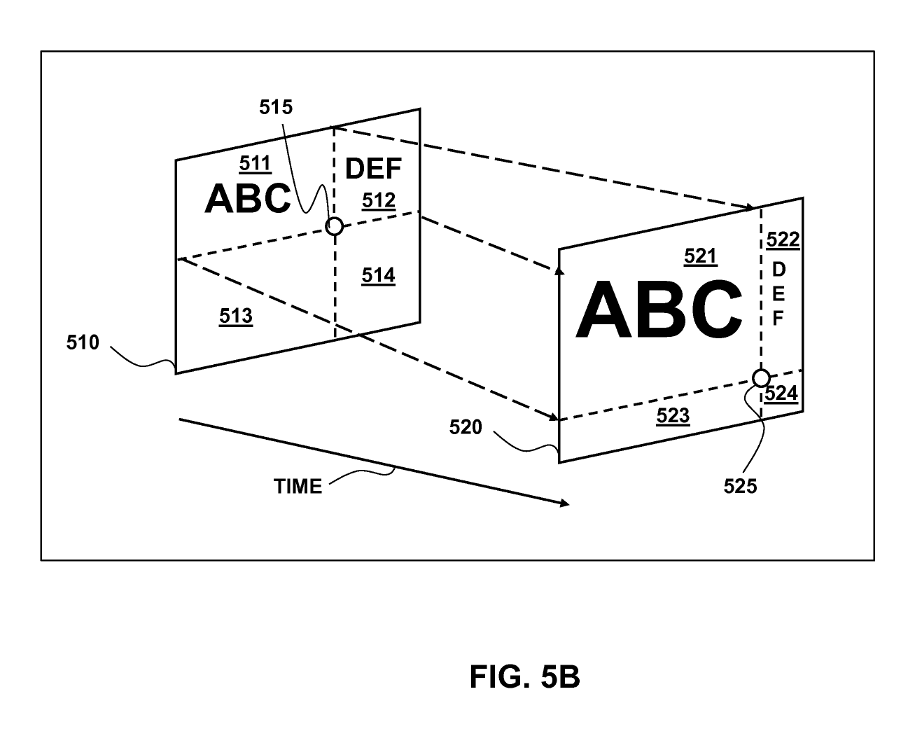

FIG. 5A depicts a set of sub-regions 500 on an image display as it has been modified according to a rule over a time period. The first in time image display 510 is depicted on a display device as having been displayed earlier in time comprising a set of four sub-regions 511-514 about an intersection 515, each with a set of viewing attributes, such as size. The second in time image display 520 is depicted on a display device as having the four sub-regions 521-524 about an intersection 525, as they have been modified based on the execution of the rule set. FIG. 5B is another exemplary depiction of the image display in time 510, and time 520 as the sub-regions have been modified temporally, where two sub-regions 511, 512 first in time 510, posses a set of viewing attributes that have been modified to display the two sub-regions 521, 522 second in time 520, according to one or more objects—disposed about a perimeter of the image display region—and based on the rule set.

In some embodiments, distances to all participants in the surrounding area may be calculated and a usage map showing the number of users, and the distances to each user may be determined. In some embodiments, a system or method may be employed to calculate the distances of the human participants present in the surrounding area to the image capture device. Optionally, the system may be set up with two identical cameras where the cameras may be mounted on the view screen, and optionally in a parallel orientation to each other. In one embodiment, the cameras may be mounted 12 inches apart and each may have a 60 degree field of view. Optionally, the cameras may each have a resolution of 1024 pixels on the horizontal axis.

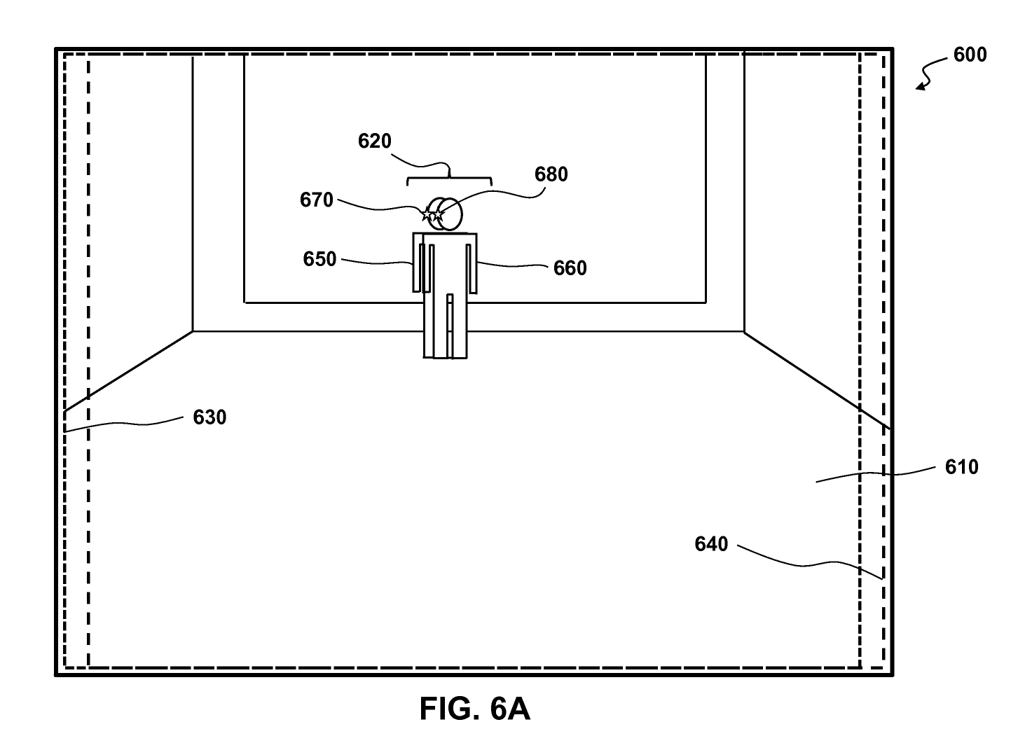

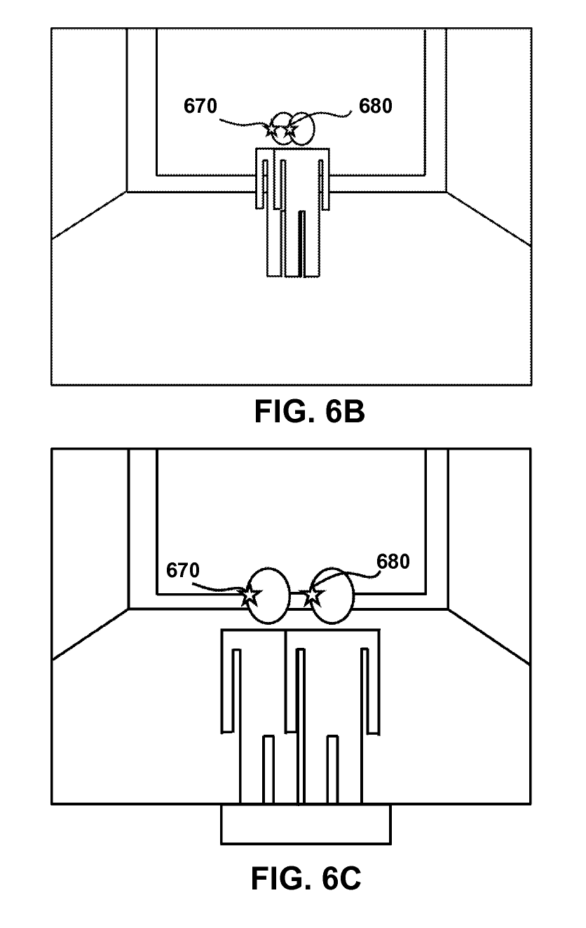

FIG. 6A depicts an environment 600 with two image capture devices where each image capture device may have a slightly different angle view of the surrounding environment, e.g., a room 610. The image capture devices each may then have a different depiction of an object, e.g., human participant 620. In this example, the image capture device may be positioned on the left side and may capture the section of the room that may be delineated by the area 630, while the image capture device that may be positioned on the right side may capture the section of the room that may be delineated by the area 640. As depicted in FIG. 6A, the image capture devices capture the human participant 620 as being positioned in a slightly different position in relation to the rest of the room where each image capture device may have a slightly different viewing reference point. The image capture device positioned on the left may capture the human participant 620 as standing in the position indicated by object 650, while the image capture device positioned on the right may capture the human participant 620 standing in the position indicated by object 660. In some embodiments, an approximately identical point on the human participant may be located. The image capture devices may capture a simultaneous image from each capture device and, for example, use face detection software to locate the human participant, e.g., faces in the room. As an example, FIG. 6A depicts two randomly selected points 670, 680 on the captured image of the human participant. The distance between the center points of the two selected points may, for example, be 15 pixels away from each other, corresponding to a distance of 25 feet from the image display.

FIG. 6B depicts the environment of FIG. 6A with two image capture devices where the distance between the two selected points 670, 680 may now be calculated, e.g., 40 pixels apart that may correspond to a distance of 12 feet from the image display. FIG. 6C further depicts the environment of FIG. 6A where the distance between the two selected points 670, 680 may now be calculated, e.g., 135 pixels apart that may correspond to a distance of six feet from the image display. In these exemplary embodiments certain aspects may be necessary for calculating the distance, such as for example: the screen resolution of the image capture devices, the angle of view of the image capture devices, the distance between the image capture devices, and/or calibration of the image capture devices to the environment, e.g., 1 pixel=Y unit of measure.

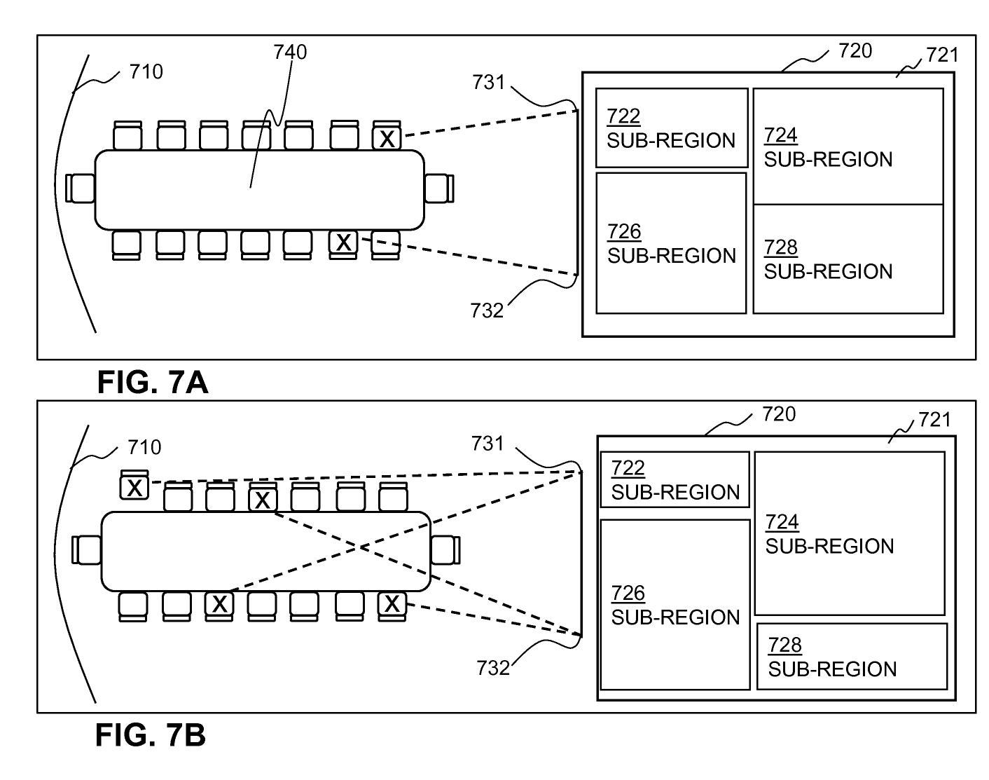

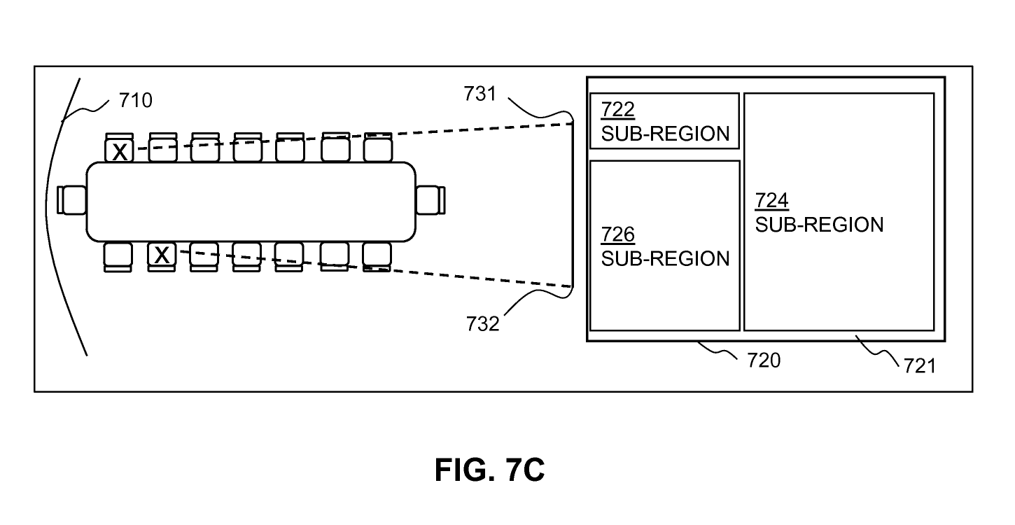

FIG. 7A depicts an exemplary environment, e.g., a boardroom or a conference room, that may comprise an image display 720 where the image display comprises a display region 721 that further comprises a set of sub-regions 722, 724, 726, 728. The boardroom is depicted as having a conference table 740 and a plurality of chairs with a number of chairs being occupied by audience members or objects, depicted with “x” icons. The image display 720 may display the set of sub-regions 722, 724, 726, 728 according to an exemplary rule set where the image capture device, shown by example as two detectors 731, 732, may detect audience members within a perimeter 710 located at a distance from the image display 720. FIG. 7B depicts the exemplary environment of FIG. 7A where the occupancy, depicted with “x” icons, of the seats have changed when compared to FIG. 7A. The audience members may be detected by the image capture device, and a distance from a reference point on the image display 720 may be determined. A new set of viewing attributes of the image display 720 may then be determined based on the new audience members and their respective and/or collective distances from the image display 720. FIG. 7C depicts the exemplary environment of FIG. 7B where the occupancy of the seats have again changed and the audience members may be located at a distance farther than those in FIG. 7A and FIG. 7B. The image capture device may re-scan the room and detect changes to the locations of the audience members. Accordingly, the viewing attributes of the image display may be re-determined based on the revised location and distances of the audience members from a reference point on the image display 720.

In some embodiments a video conference room may be equipped with at least one camera which may be mounted on top of the video display unit. Alternatively, a display may have one or more cameras integrated into the display, for example, in the housing, in the display, or embedded within the makeup of the LCD screen. In an embodiment where the audience members may all be sitting at an equal distance to the image display, the viewing attributes may be modified and sub-region sizes and font sizes may be adjusted to match the viewing distances. In some embodiments the audience members may be sitting at mixed distances to the image display and the viewing attributes may be modified and sub-region sizes and font sizes may be adjusted based on the audience member distances.

In some embodiments, sub-regions may be tagged as low, medium, normal, or high priority of display; one that may have been tagged as low priority may be minimized in order to allow for more room on the screen for the other normal priority sub-regions. In an embodiment where the audience members may all be sitting at a distance from the image display, viewing attributes may be modified and the sub-region and the font sizes may be adjusted to match the viewing distances. Optionally, a sub-region that may have been tagged as medium priority may be displayed, for example, in the normal-default size, and may be partially covered by the other sub-regions.

In some embodiments, a system administrator may set up rules that may determine the appropriate re-sizing responses and change the image display attributes accordingly to different scenarios that may, for example, be based on the size of the surrounding area and/or usage of the equipment. Optionally, an administrator may set up rules to determine audio attributes as well as the display attributes changes, based on different scenarios. In some embodiments, the administrator may determine the frequency with which the room may be scanned and the image display attributes re-determined. Optionally, a single, on-demand, re-scan by the image display device may be initiated and a re-determination of the image display attributes, according to the re-scan, may be implemented. In some embodiments, the dynamic sub-region attribute adjustment system may optionally be turned off.

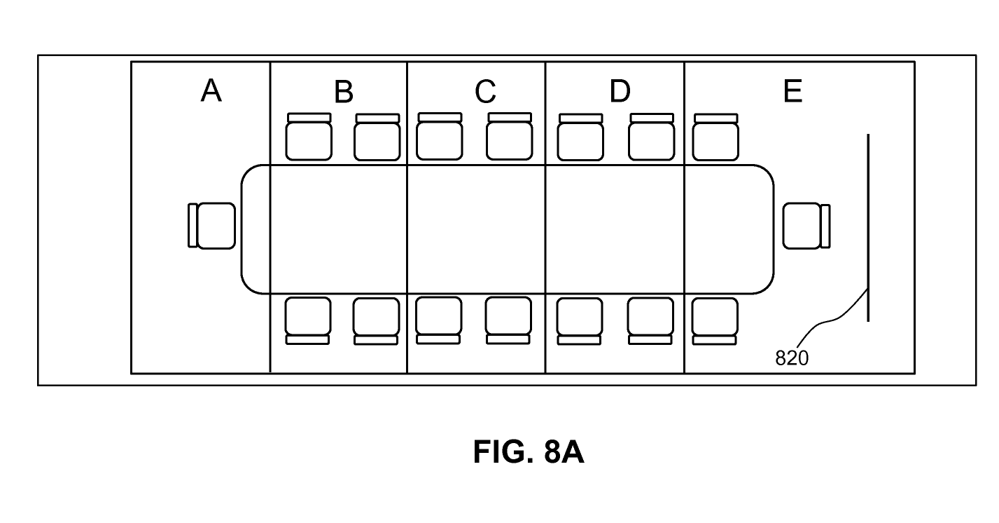

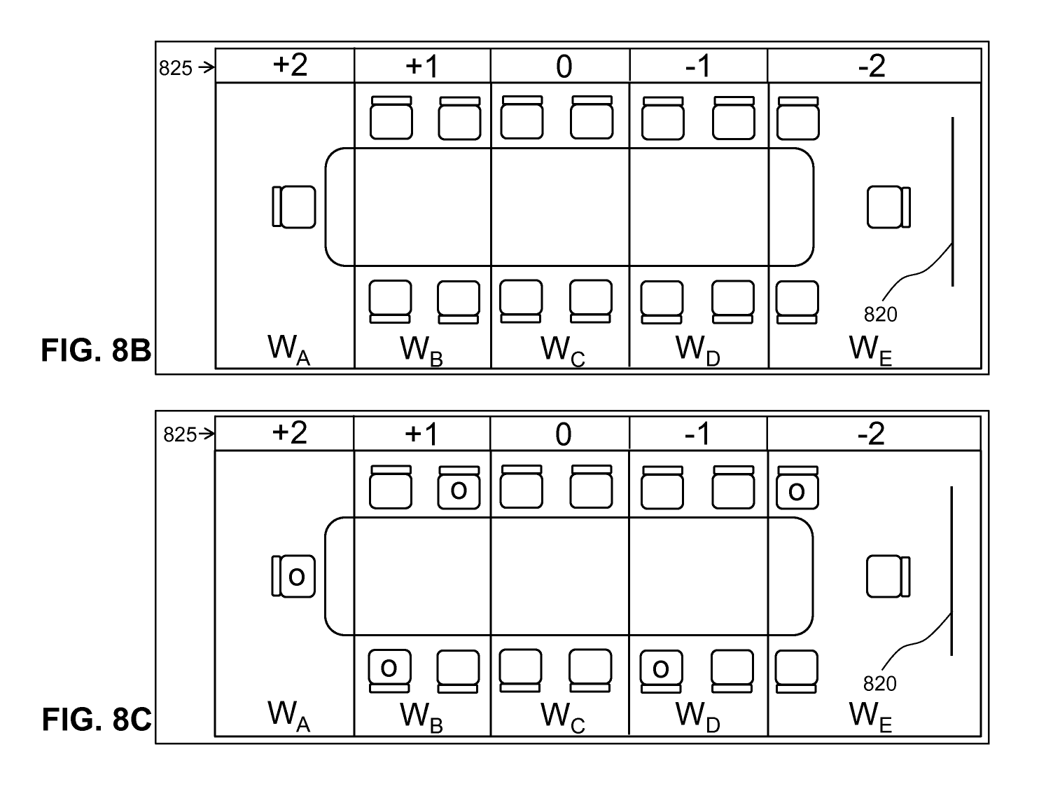

FIGS. 8A-8C depict an embodiment of an environment, e.g., a boardroom or a conference room, where the room may be apportioned according to a set of zones and each zone may be given a weighting factor. FIG. 8A depicts an exemplary boardroom as having five zones A, B, C, D, and E, each disposed within a proximate perimeter portion or a centroid, for example, at a particular distance from the image display 820. The set of zones may be predetermined or determined: based on the objects in the surrounding area or, in some embodiments, may be based on the disposition of audience members. Accordingly, in this embodiment the viewing attributes may be determined without having exact distances of each object, e.g., audience member, to the image display 820. Each of the audience members may be mapped into a particular zone from the set of determined zones. In some embodiments, an administrator may determine the number of zones based on the particular environment. FIG. 8B depicts the exemplary boardroom of FIG. 8A as having five zones, each zone being associated with a weighting factor: W_{A}, W_{B}, W_{C}, W_{D}, and W_{E}, corresponding to a set of values 825, e.g., +2, +1, 0, −1, −2. FIG. 8C depicts the exemplary boardroom with a set of audience members each disposed about the boardroom at different distances from the image display 820. The associated weighting factor for each zone may provide for a balanced audience distribution where an audience member may be creating an “outlier” condition.

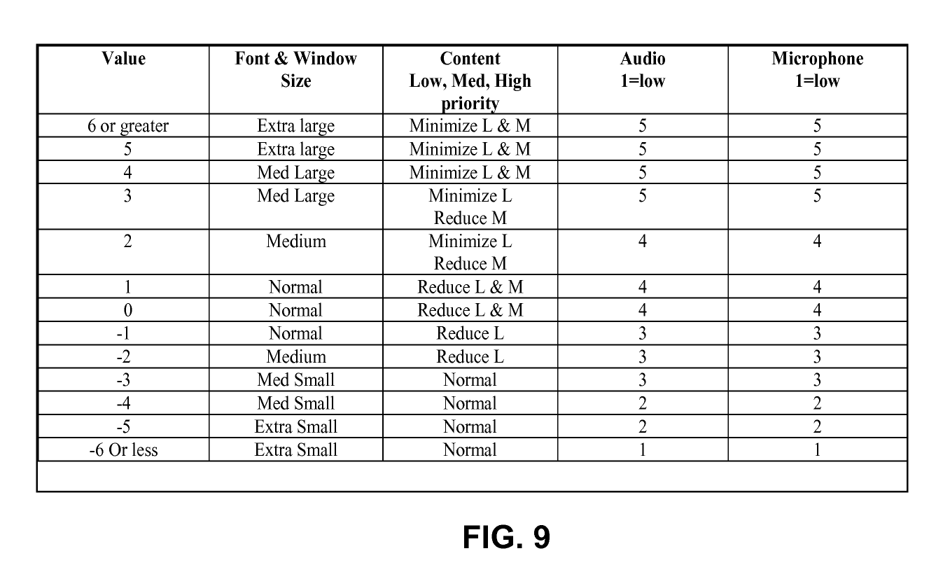

FIG. 9 is an exemplary table of values according to an exemplary weighting factor calculation rule set of FIGS. 8B-8C. As an example, the following applied equation—in accordance with FIG. 8C—may yield a value corresponding to the value column of the table:

(1*+2)+(2*+1)+(0*0)+(1*−1)+(1*−2)=2+2+0+−1+−2=1

As shown, the resulting value may determine the viewing attributes and disposition of the set of sub-regions on the image display. Optionally, various methods may be used to determine the rule set which may control the image display and other environmental attributes.

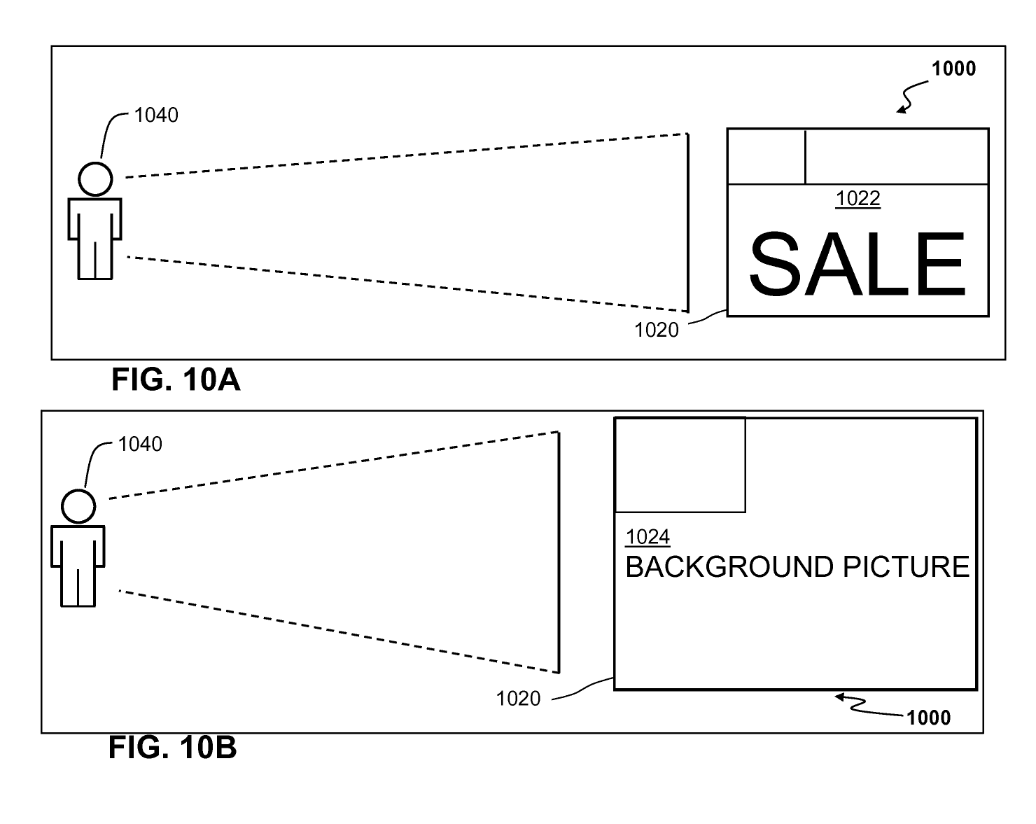

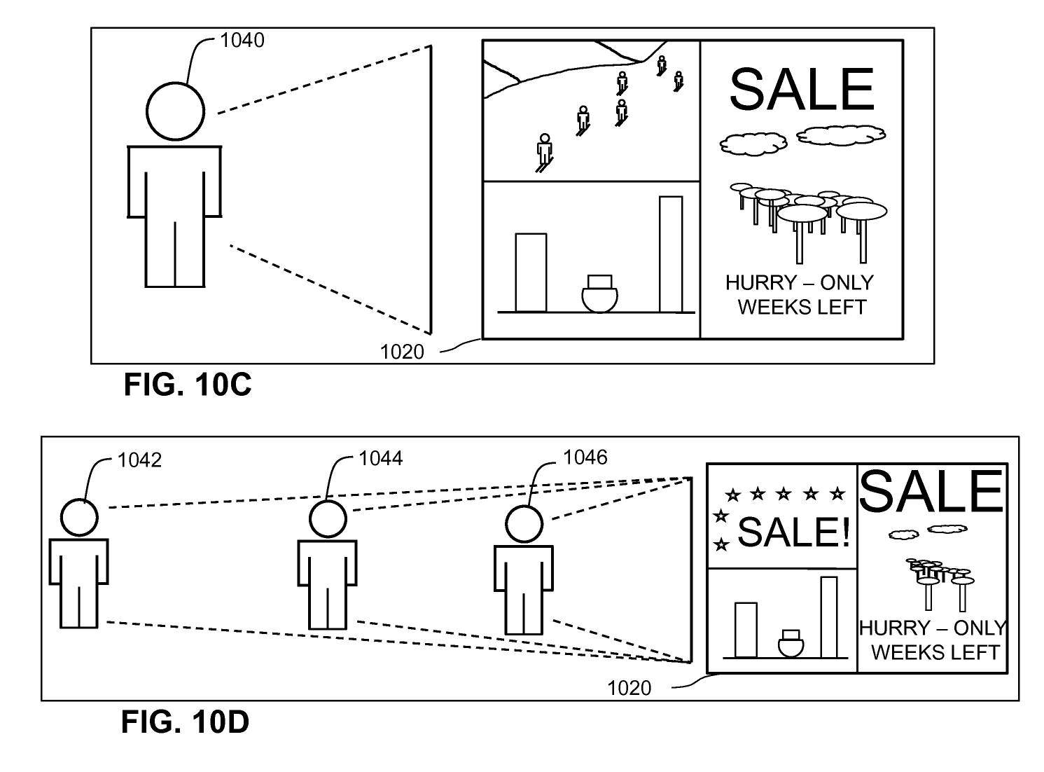

FIGS. 10A-10D depict a digital signage environment 1000, where an object, e.g., a potential customer 1040, may be at a distance from the viewing image display 1020. In some embodiments, viewing attributes, e.g., larger fonts and graphics, may be displayed on the image display 1020 based on the distance of a potential customer to the image display 1020. In the embodiment where larger messages may be displayed, the messages may contain limited content 1022. FIG. 10A depicts a potential customer 1040 as being a distance—within a perimeter—from the image display 1020. The image display 1020, according to a rule set, may use larger font sizes and display a limited set of content 1022. FIG. 10B depicts the potential customer 1040 as having moved to a closer distance to the image display 1020 as from FIG. 10A. In some embodiments, the size of the message being displayed may be modified and the content may be increased to adapt to the viewer being at a closer distance. For example, FIG. 10B shows the viewing attributes as having been modified and a smaller font size and additional content 1024 being displayed on the image display 1020. Optionally, the additional information may be of any type or format, e.g., more detailed text, graphics, or video. FIG. 10C depicts the potential customer 1040 as having moved to a closer distance to the image display 1020 as from FIG. 10B. The viewing attributes may be modified in accordance to the distance of the potential customer 1040 and, for example, a video may start streaming or a multi-media presentation may begin, and may provide additional details regarding the content being displayed on the image display 1020. FIG. 10D depicts a plurality of potential customers 1042, 1044, 1046 at different distances from the image display and a set of sub-regions within the image display each with a set of viewing attributes and content details, e.g., large, medium, or small. In some embodiments a system administrator may set up rules that guide the appropriate responses to each scenario, based on the size of the environment and/or the location of the signage.

In some embodiments, methods of determining distances to a set of objects may be based on, for example, multiple cameras and basic trigonometry, a single camera using an average, normalized, size model of a human face, a single camera using a method such as infrared light, laser range-finder, or sonar range-finding.

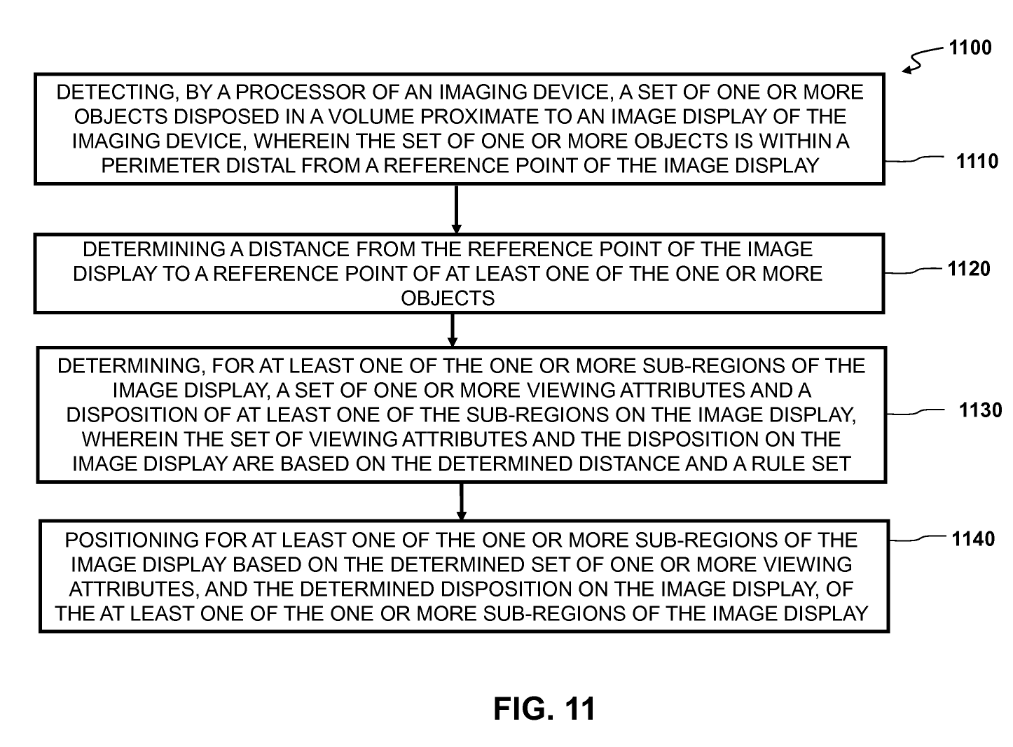

FIG. 11 is a flowchart of an exemplary method of a dynamic sub-region attribute adjustment applied in a system 1100 in which the system comprises an image display and computer and/or computing circuitry that may be configured to execute the steps as depicted. The method depicted in the flowchart includes the steps of: (a) detecting, by a processor of an imaging device, a set of one or more objects disposed in a volume proximate to an image display of the imaging device, wherein the set of one or more objects is within a perimeter distal from a reference point of the image display (step 1110); (b) determining a distance from the reference point of the image display to a reference point of at least one of the one or more objects (step 1120); (c) determining, for at least one of the one or more sub-regions of the image display, a set of one or more viewing attributes and a disposition of at least one of the sub-regions on the image display, wherein the set of viewing attributes and the disposition on the image display are based on the determined distance and a rule set (step 1130) and, position the one or more sub-regions on the image display based on the determined set of one or more viewing attributes and the determined disposition of the one or more sub-regions (step 1140).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention is herein disclosed by way of examples and should not be limited by the particular disclosed embodiments described above.

What is claimed is:

1. A device comprising:
an image display, the image display comprising one or more sub-regions disposed on the image display, each of the one or more sub-regions having a set of one or more viewing attributes;
an addressable memory, the memory comprising a rule set, wherein the sub-regions of the image display are responsive to at least one member of the rule set; and
a processor configured to:
detect a set of one or more objects disposed in a volume proximate to the image display and within a perimeter distal from a reference point of the image display;
determine a distance from the reference point of the image display to a reference point of the one or more objects; and
determine the set of one or more viewing attributes and the disposition of the one or more sub-regions of the image display, wherein the viewing attributes and disposition of the one or more sub-regions are based on the determined distance of the one or more objects and at least one member of the rule set.

2. The device of claim 1 wherein the processor is further configured to
position the one or more sub-regions on the image display based on the determined set of one or more viewing attributes and the determined disposition of the one or more sub-regions.

3. The device of claim 1 wherein the processor is further configured to
determine a level of audio output based on the determined set of viewing attributes and the determined distance.

4. The device of claim 1 wherein the processor is further configured to
determine a set of one or more regional elements, wherein each regional element comprises a weighting factor associated with each of the one or more objects.

5. The device of claim 4 wherein the set of regional elements is determined based on the weighting factor associated with each of the one or more objects and based on the determined distance of the one or more objects disposed within the volume.

6. The device of claim 1 wherein each of the one or more sub-regions is associable with a priority of display.

7. The device of claim 6 wherein the processor is further configured to
determine the set of viewing attributes and the disposition of the one or more sub-regions of the image display based on the associable priority of display of the one or more sub-regions.

8. The device of claim 1 wherein the set of viewing attributes comprises at least one of: a set of dimensions in proportion to a set of dimensions of the image display; a set of font types; a set of font sizes; and a set of display content.

9. The device of claim 1 wherein the processor is further configured to
determine the distance from the reference point of the image display to the reference point of the one or more objects via at least one of: a triangulation method, a trilateration method, and a multilateration method.

10. A method comprising:
detecting, by a processor of an imaging device, a set of one or more objects disposed in a volume proximate to an image display of the imaging device, wherein the set of one or more objects is within a perimeter distal from a reference point of the image display;
determining a distance from the reference point of the image display to a reference point of at least one of the one or more objects; and
determining, for at least one of the one or more sub-regions of the image display, a set of one or more viewing attributes and a disposition on the image display of the at least one of the one or more sub-regions, wherein the set of viewing attributes and the disposition on the image display are based on the determined distance and a rule set.

11. The method of claim 10 further comprising
positioning for at least one of the one or more sub-regions of the image display based on the determined set of one or more viewing attributes, and the determined disposition on the image display, of the at least one of the one or more sub-regions of the image display.

12. The method of claim 10 further comprising
determining a level of audio output based on the determined set of viewing attributes and the determined distance.

13. The method of claim 10 further comprising
determining a set of one or more regional elements, wherein each regional element comprises a weighting factor associated with each of the one or more objects.

14. The method of claim 13 wherein the set of regional elements is determined based on the weighting factor associated with each of the one or more objects and based on the determined distance of the one or more objects disposed within the volume.

15. The method of claim 11 wherein each of the one or more sub-regions is associable with a priority of display.

16. The method of claim 15 further comprising determining
the set of viewing attributes and the disposition of the one or more sub-regions of the image display based on the associable priority of display of the one or more sub-regions.

17. The method of claim 11 wherein the set of viewing attributes comprises at least one of: a set of dimensions in proportion to a set of dimensions of the image display; a set of font types; a set of font sizes; and a set of display content.

18. The method of claim 11 further comprising
determining the distance from the reference point of the image display to the reference point of the one or more objects via at least one of: a triangulation method, a trilateration method, and a multilateration method.

19. A system comprising:
an image display device, the image display device comprising an image display region comprising one or more sub-regions disposed on the image display, each of the one or more sub-regions having a set of one or more viewing attributes, the image display operably coupled to an image capture device, the image display comprising:
a memory configured to store a rule set, wherein the sub-regions of the image display are responsive to at least one member of the rule set;
a processor configured to:
detect a set of one or more objects disposed in a volume proximate to the image display and within a perimeter distal from a reference point of the image display;
determine a distance from the reference point of the image display to a reference point of the one or more objects;
determine the set of one or more viewing attributes and a disposition of the one or more sub-regions of the image display, wherein the viewing attributes and disposition of the one or more sub-regions are based on the determined distance of the one or more objects and at least one member of the rule set; and
position the one or more sub-regions on the image display based on the determined set of one or more viewing attributes and the determined disposition of the one or more sub-regions.
